(19) United States
(12) Patent Application Publication
(10) Pub. No.: US 2012/0133763 A1
(43) Pub. Date: May 31, 2012

(54) DEVICE AND METHOD FOR FLAW LOCATION DETECTION IN FABRIC AND MARKINGS

(75) Inventors: Thomas Schramboeck, Berndorf (AT); Andreas Baci, Ternitz (AT)

(73) Assignee: Starlinger & Co Gesellschaft m.b.H, Wein (AT)

(21) Appl. No.: 13/375,978

(22) PCT Filed: May 19, 2010
(86) PCT No.: PCT/EP2010/056922

§ 371 Date: Jan. 12, 2012

(30) Foreign Application Priority Data
Jun. 5, 2009 (AT) A 873/2009

(51) Int. Cl. H04N 7/18

(52) U.S. Cl. 348/125; 348/E07.085

(57) ABSTRACT

The invention relates to a device for detecting flaws in a plastic woven fabric made of monoaxially drawn polymer ribbons, in particular polyolefin ribbons, preferably polypropylene ribbons, wherein in order to monitor irregularities, which are characteristic of flawed sections of the plastic woven fabric, an inspection camera is provided for taking images of the plastic woven fabric, and an analysis unit, which detects irregularities in the weaving pattern of the plastic woven fabric on the basis of the images taken by the inspection camera and which, when detecting irregularities in the weaving pattern indicating a flawed section of the plastic woven fabric, triggers an error signal, which actuates, for example, a flashing light or a horn, or which can be fed to a higher-level machine controller. There is further provided a labelling device for attaching labels to the plastic woven fabric, wherein the labelling device is actuated directly or indirectly by the error signal, in order to attach at least one label to a flawed section.

The invention relates to a device for detecting flaws in a plastic woven fabric made of monoaxially drawn polymer ribbons, in particular polyolefin ribbons, preferably polypropylene ribbons, which is optionally coated with a thermoplastic material on one or two sides, wherein in order to monitor irregularities, which are characteristic of flawed sections of the plastic woven fabric, an inspection camera is provided for taking images of the plastic woven fabric, and an analysis unit, which detects irregularities in the weaving pattern of the plastic woven fabric on the basis of the images taken by the inspection camera and which, when detecting irregularities in the weaving pattern indicating a flawed section of the plastic woven fabric, triggers an error signal, which actuates, for example, a flashing light or a horn, or which can be fed to a higher-level machine controller. There are further provided an inspection system for monitoring flaws of a plastic woven fabric as well as variants of a method for labelling or monitoring, respectively, flaws of a plastic woven fabric.

Many powdery or bulkable consumer goods today are filled, stored and transported in bags made of plastic woven fabric. It is essential that the bags made of plastic woven fabric that are used meet the quality requirements for the respective purpose of use.

Plastic bags for the packaging of particulate goods such as, for example, cement have to be sufficiently firm and dust-tight in order to prevent contamination or exit of particles, respectively, during the process of filling, storage as well as transportation and, hence, also contribute to the protection of the environment. Plastic bags for the packaging of free-flowing chemicals, furthermore, have to meet in addition strict requirements in terms of occupational safety as well as requirements regarding the resistance of the material used against weather influences.

Quality assurance becomes even more important already in the production of plastic woven fabrics, from which there are made, for example, plastic bags.

From WO 2008/116653 A1 there are known quality assuring measures for a bag filling method, wherein particulate or granulate bulk is filled into plastic bags. In this filling method there are taken measures into account preventing the exit of particles during the process of filling. Further, there are taken measures intended to prevent that, due to too high filling rate, the level of goods filled in is initially higher in the plastic bags than later on during storage.

If the package size of the plastic bags is selected too big for the content or if the bulk density is too low due to a too quick filling process and, hence, the filled bags are not sufficiently stable in their form, the safe storage thereof, for example on a pallet, is not possible. The consequence may be occupational injuries and contamination due to collapsing filled plastic bags or leaking bulk goods. As a counter-measure in order to increase the bulk density for particulate bulk goods, there is proposed an especially slow, dosed filling process of the plastic bags.

This bag filling method is insofar disadvantageous as all measures for quality assurance are provided exclusively from the beginning of the filling process for a plastic bag on. The fact that a material flaw of the used plastic woven fabric may result in a tear of the bag or that plastic bags may be leaking is accepted or assumed, respectively, in connection with this filling method. As a solution there are exclusively proposed measures for the early detection of such damage, in order to provide for the shut-down of the filling device in time.

Inspection of the material quality of the plastic bags to be filled before the filling step—or even more advantageously—already during the production of the plastic woven fabric is not envisaged at all.

From WO 2005/035862 A1 there is known a method for processing signals, which may be obtained by scanning textile areas. On the basis of these signals there are calculated values for pre-selected parameters, wherein there are predetermined threshold values for the values of the parameters intended for determining flaws. Depending on the characteristic of the flaws detected, there may, for example, be triggered an alarm, or the drive means may be stopped.

WO 2005/085813 A1 relates to a device for monitoring a moving web of material at a textile machine, wherein a line sensor is arranged for scanning the web of material along its width. A sensor signal of the line sensor, for example a CCD—opto-electric line sensor, is then processed by an electronic circuit into a configurable starting signal that triggers an action. Such a starting signal is suited to trigger, for example, the shut-down of the drive means for the web of material or the initiation of an optical or acoustic alarm.

From DE 43 12 452 A1 there is known a method for optically determining quality-defining parameters of textile surfaces by means of imaging sensors. Therefore, the textile surface is detected section-wise by a line camera, and the digital image is subsequently analyzed in regard to homogeneity, orientation as well as number of the meshes and trebles or weft and warp threads, respectively, of the periodically structured web of material or knitted goods.

DE 33 04 817 A1 discloses a method for automatically detecting flaws in textile fabrics using image filtration in order to increase the contrast between the global texture that is considered normal for the textile to be examined and the local deviations that are considered as flawed. Therefore, there are used at least two spatial filters for image transformation that are adjusted to the detection of straight-lined contour elements. Error signals obtained via digital image filtration are thus stored and analyzed by a down-stream processor.

Producers and traders, respectively, of packaging bags made of plastic material are increasingly facing the problem that operators of automated filling plants detect a flawed bag in the course of incoming goods inspections on a random basis, so that a complete pallet or charge of hundreds or thousands of plastic bags will be reclaimed and will have to be taken back by the supplier. The economic damage arising thereof is tremendous.

First approaches of individual bag producers to detect flaws in the material already during the production of a plastic woven textile early on and to label these manually by means of coloured marks have not been fully developed so far. Because of fast running processing machines, which will achieve web rates of the plastic woven fabric of up to 300 m/min, a complete and purely optical inspection in regard to flaws by the operating personnel is virtually impossible. A coloured marking of a flaw, for example at a flat web of material, which in the subsequent process steps of the bag production is formed or closed, respectively, into a fabric tube, may thus later on be situated on the inside of this fabric tube and will thus not be detected in a down-stream optical quality control. The same is effective for coloured marks which, if the plastic webs in the course later on are printed on, will not be detectable anymore. Furthermore, depending on the customer's requirements, there is to be distinguished which flaw sizes are to be eliminated. Large-scale or long flaws occurring along several metres of a section of the plastic woven fabric are more prone to be detected by the operating personnel than small-scale flaws. A reliable monitoring system for detecting a flawed section of a plastic woven fabric, the sensitivity of which in regard to the flaw detection may be adjusted according to the customer's requirements, which marks all flaws occurring and also detects these following one or several subsequent process steps of the plastic woven fabric, has so far not been known.

Thus it is the aim of the present invention to prevent the disadvantages known in prior art and to provide a device for detecting flaws in a plastic woven fabric. Another aim of the invention is to provide an inspection system for monitoring flaws using such a device for detecting flaws.

According to the invention, this aim is solved by a device for detecting flaws according to this type by means of the characteristics mentioned in the characterizing part of claim 1. Especially preferred embodiments and developments of the invention are object of the sub-claims.

A device according to the invention for detecting flaws in a plastic woven material made of monoaxially drawn polymer ribbons, in particular polyolefin ribbons, preferably polypropylene ribbons, which is optionally coated with a thermoplastic material on one or two sides, comprising, in order to monitor irregularities, which are characteristic of flawed sections of the plastic woven fabric, an inspection camera for taking images of the plastic woven fabric, and an analysis unit, which detects irregularities in the weaving pattern of the plastic woven fabric on the basis of the images taken by the inspection camera and which, when detecting irregularities in the weaving pattern indicating a flawed section of the plastic woven fabric, triggers an error signal. The error signal actuates, for example, a flashing light or a horn, or it can be fed to a higher-level machine controller.

Depending on the customer's requirements, there are further possible also combinations, for example of an acoustic alarm signal and the transfer of a signal to the higher-level machine controller, when an error signal is triggered.

A device for detecting flaws in a fabric according to the invention is advantageously provided with a user-interface for adjusting the sensitivity of the flaw detection of the analysis unit, which makes it possible for the user to individually make a selection of the sections of the plastic woven fabric to be labelled as flawed.

Based on the possibility to individually adjust the sensitivity of the flaw detection, the most varied quality requirements may be fulfilled, according to the respective customer wishes or the later purpose of use, respectively, intended for the plastic woven fabric.

A device for detecting flaws in a fabric according to the invention is usefully provided with a labelling device for attaching labels to the plastic woven fabric, wherein the labelling device is directly or indirectly actuated by the error signal in order to attach at least one label to the flawed section.

In particular in the case of fast running production machines of plastic woven fabrics, it is advantageous if a labelling device, which may be actuated by an error signal of a higher-level machine controller, locally determines flawed sections by means of labels.

In a useful embodiment variant of the inventive device for detecting flaws in a fabric, according to the length of a flawed section of the plastic woven fabric, the labelling device will attach several labels to such a flawed section, preferably at least one label at the beginning and at the end of the flawed section, in particular several labels uniformly distanced alongside the flawed section.

Depending in turn on the customer's requirements or the later final product, respectively, which will be made from the plastic woven fabric, it may be useful to attach several labels alongside a flawed section. If, for example, there are produced plastic bags for packing chemicals from the fabric, which must not have any fabric flaws, it may be necessary to attach a first label for labelling this section already one bag length in advance of the beginning of the section detected as flawed, in order to reliably prevent that a flawed fabric material is used for the production of a plastic bag. Correspondingly, the same is true for the end of a section detected as flawed, wherein it may also be necessary, depending on the quality requirements, to label one or also several bag lengths of the fabric already produced without any flaws. In the case of longer flaws, if, for example, ribbons of the plastic woven fabric are entwined on top of each other along several metres, it may be necessary in order to meet the highest quality standards to attach a plurality of labels uniformly distanced from each other along the flaw of the plastic woven fabric and, hence, indicate the entire section. In order to reliably guarantee that also after several subsequent production steps, wherein a continuous web of material has been cut into several short sections of the same length, for example, alongside its length, later on a flaw will still be detectable and, hence, may be eliminated from the production process.

In an advantageous development of the invention, there is provided a device for identifying flaws that are indicated by means of labels in a plastic woven fabric, comprising a label sensor for detecting the position of the labels at the plastic woven fabric and a processing unit, which identifies the flawed sections of the plastic woven fabric by means of the label positions detected by the label sensor.

A device for identifying flaws in the fabric according to the invention advantageously comprises a discharge station separating the flawed sections of the plastic woven fabric identified by the processing unit.

In a useful embodiment of the device for identifying flaws in the fabric according to the invention the label sensor operates on an inductive base and, hence, detects labels provided with an electrically conductive layer.

Such labels provided with an electrically conductive layer provide the guarantee to be detected by an inductive label sensor even if they have already been printed together with the plastic woven fabric or if following several production steps, wherein the plastic woven fabric is, for example, folded into bags, they are then situated on the lower side or the inside of a folded bag.

A label sensor of a device for identifying flaws in a fabric according to the invention usefully detects labels, which consist of several layers and comprise a plastic support layer, an electrically conductive layer applied to the plastic support layer as well as an adhesive layer, preferably an acrylic adhesive on the basis of a dispersion.

Advantageously, the label sensor detects such labels, which have a layer thickness of the plastic support layer of between 120 and 150 μm and a layer thickness of the electrically conductive layer of less than 0.1 μm.

Such labels will usually not be detected by the metal detectors of plastic recycling machines provided there for a control of the incoming goods. There is not to be expected any impairment of the quality of the recycled plastic material by a small portion of integral label parts. Furthermore, advantageously very small-scale labels are sufficient to indicate a flawed section of the fabric.

In a variant of a device for identifying flaws in a fabric according to the invention, the label sensor is configured as an optical label sensor detecting labels made of optically opaque material, preferably of optically opaque plastic material.

There is to be noted that there is selected such an optical label sensor so that the wave length of the emitting light thereof will not be absorbed by the material of the plastic woven fabric, or only partially. A high extinction of the light emitted, which may be caused by the material of the plastic woven fabric or a print colour already applied to the fabric, will for the most part result in the labels being not detected by the optical label sensor with sufficient reliability.

In particular advantageously, there will not be attached any undesired substances at the plastic woven fabric in use of the plastic labels. Hence, there is not to be expected any impairment of the material quality for a subsequent recycling step of the plastic waste.

In a development of the invention, there is provided an inspection system for monitoring flaws of a plastic woven fabric made of monoaxially drawn polymer ribbons, in particular polyolefin ribbons, preferably polypropylene ribbons, which is optionally coated with thermoplastic material on one or two sides, which comprises a device for detecting flaws in a fabric and a device for identifying flaws in a fabric.

By means of such an inventive inspection system for monitoring flaws it is possible to completely monitor a complex and multi-stage production process, for example the production of folded plastic bags made of plastic woven fabric. A flawed section of the plastic woven fabric will, for example, be directly upon production of the fabric be detected and immediately marked by means of labels by the device for detecting flaws. Then there may be carried out a plurality of further production steps, as are necessary, for example, for the production of bags made of plastic woven fabric. The correspondingly indicated flaw will be identified by the device for identifying flaws in one of the subsequent production steps and then separated from the current production line in a discharge station.

Instead of an own discharge station, it is also possible that flawed sections of the plastic woven fabric will also be manually separated by the operating personnel. Thereby, there is, for example, emitted an alarm signal by the device for identifying flaws in a fabric, as soon as a flaw has been identified.

A method according to the invention for indicating flaws of a plastic woven fabric that is preferably continuously moved is characterized by the following steps of procedure:
inspection of the plastic woven fabric,
detection of irregularities in the weaving pattern of the plastic woven fabric,
upon detection of irregularities of the weaving pattern indicating a flawed section of the plastic woven fabric, attachment of at least one label to the flawed section of the plastic woven fabric.

A method according to the invention for monitoring flaws of a plastic woven fabric indicated in particular according to the method for indicating flaws is characterized by the following steps of procedure:
detection of labels in a plastic woven fabric,
identification of flawed sections of the plastic woven fabric on the basis of the positions of the labels detected as well as
separation of the sections identified as flawed either manually or by means of a discharge station controlled by a processing unit.

A sequence of the procedural steps of the method for indicating flaws and of the subsequent procedural steps of the method for monitoring flaws guarantees a monitoring of the process of the entire method for the production of a plastic woven fabric.

Further features of the invention will become clear by way of the following description of exemplary embodiments and in reference to the drawing.

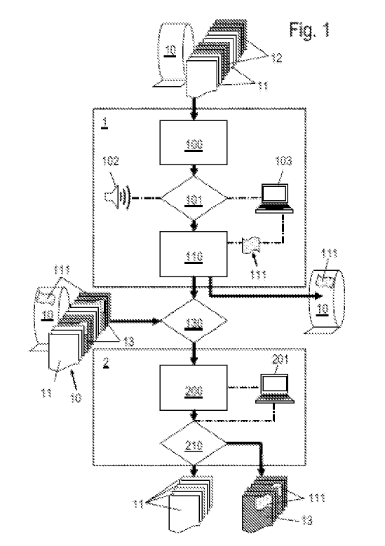

FIG. 1 shows in a schematic illustration an embodiment of an inventive inspection system for monitoring flaws of a plastic woven fabric.

Depending on the respective customer wishes or product requirements, respectively, the term of the plastic woven fabric comprises all possible types of production or storage, respectively, of a plastic woven fabric, for example as reel goods but also as a stack of individual sections of a plastic woven fabric stacked upon each other.

A flawed section 12 of a plastic woven fabric 10 is detected by a device 1 for detecting flaws in a fabric of the inspection system, by an inspection camera 100 or by an analysis unit 101, respectively.

The inspection camera 100 therefore continuously takes images of the preferably continuously moved web of plastic woven fabric 10 and transmits these images to the analysis unit 101. Irregularities in the weaving pattern of the plastic woven fabric 10, which are caused, for example, by a torn ribbon or by ribbons being situated on top of each other in multiple layers, are detected as flawed sections 12 by the analysis unit 101, which then triggers an error signal 102, which may be, e.g. a flash light, a horn or a comparable alarm signal. The error signal 102 may also be fed to a machine controller 103, which, for example, then controls a labelling device 110, whereupon there is attached a label 111 to the flawed section 12 by the labelling device 110 for the later identification thereof.

Further possible is the combination of an acoustic and/or optical alarm signal and the error signal 102 being simultaneously fed to the higher-level machine controller 103 for further control.

The flawed sections 13 of the plastic woven fabric 10 provided with one or if required respectively several labels 111 in such a way may be distinguished in the later production course in a simply way from the flawless sections 11 of the plastic woven fabric 10. Thus it is possible to put on stock and at a later point of time re-introduce into the further production process 130 a plastic woven fabric 10 provided with labels 111. The further production process 130 may comprise one or several processing steps, in particular printing, laminating, moulding and/or tube shaping of the plastic woven fabric.

The marked fabric 10, wherein the flawed sections 13 already provided with labels 111 are easy to be identified, will be detected by a label sensor 200 of a device 2 for identifying flaws in a fabric upon performing one or several steps of the further production process 130, for example after printing or cutting the plastic woven fabric 10. The label sensor 200, which operates, for example, on an inductive basis, detects the labels 111 provided with an electrically conductive layer on the basis of the position thereof at the plastic woven fabric 10. A processing unit 201 connected with the label sensor 200 identifies, by way of the label positions detected by the label sensor 200, the flawed sections 13 of the plastic woven fabric, which will then be separated in a discharge station 210 from the further production course. Hence, there are provided only flawless sections 11 for the further processing of the plastic woven fabric 10.

Alternatively to the embodiment comprising a label sensor 200 operating on an inductive basis, there may also be used an optical label sensor. In this way there may also be used labels 111 that are optically opaque but produced without provision of an electrically conductive layer.

According to the customer's requirements, there may also be used other corresponding embodiments of label sensors in an inventive inspection system for monitoring flaws of a plastic woven fabric.

1. A device for detecting flaws in a plastic woven fabric made of monoaxially drawn polymer ribbons, in particular polyolefin ribbons, preferably polypropylene ribbons, which is optionally coated with a thermoplastic material, in particular polyolefin, on one or two sides, wherein in order to monitor irregularities, which are characteristic of flawed sections of the plastic woven fabric, an inspection camera is provided for taking images of the plastic woven fabric and an analysis unit, which detects irregularities in the weaving pattern of the plastic woven fabric on the basis of the images taken by the inspection camera and which, when detecting irregularities in the weaving pattern indicating a flawed section of the plastic woven fabric, triggers an error signal, which actuates, for example, a flashing light or a horn, or which can be fed to a higher-level machine controller, further characterized in that there is provided a labelling device for attaching labels to the plastic woven fabric, wherein the labelling device is actuated directly or indirectly by the error signal, in order to attach at least one label to a flawed section.

2. A device for detecting flaws in a fabric according to claim 1, characterized by a user-interface for adjusting the sensitivity of the flaw detection of the analysis unit, which makes it possible for the user to individually make a selection of the sections of the plastic woven fabric to be labelled as flawed.

3. A device for detecting flaws in a fabric according to claim 1, characterized in that according to the length of a flawed section of the plastic woven fabric, the labelling device will attach several labels to this section, preferably at least one label at the beginning and at the end of the flawed section, in particular several labels uniformly distanced alongside the flawed section.

4. A device for identifying flaws in a plastic woven fabric labelled by labels, characterized by a label sensor for detecting the position of the labels at the plastic woven fabric and by a processing unit, which identifies the flawed sections of the plastic woven fabric detected by the label sensor.

5. A device for identifying flaws in a fabric according to claim 4, characterized by a discharge station separating the flawed sections of the plastic woven fabric identified by the processing unit.

6. A device for identifying flaws in a fabric according to claim 4, characterized in that the label sensor operates on an inductive base and, hence, detects labels provided with an electrically conductive layer.

7. A device for identifying flaws in a fabric according to claim 6, characterized in that the label sensor detects labels, which consist of several layers and comprise a plastic support layer, preferably made of polyethylene, an electrically conductive layer applied to the plastic support layer as well as an adhesive layer, preferably an acrylic adhesive on the basis of a dispersion.

8. A device for identifying flaws in a fabric according to claim 7, characterized in that the label sensor is an optical label sensor detecting labels made of optically opaque material, preferably of optically opaque plastic material.

9. An inspection system for monitoring flaws in a plastic woven fabric made of monoaxially drawn polymer ribbons, in particular polyolefin ribbons, preferably polypropylene ribbons, which is optionally coated with a thermoplastic material, in particular polyolefin, on one or two sides, characterized by a device for detecting flaws in a fabric according to claim 1.

10. A method for labelling flaws of a preferably continuously moved plastic woven fabric, characterized by inspecting the plastic woven fabric, detecting irregularities in the weaving pattern of the plastic woven fabric and, when detecting irregularities in the weaving pattern of the plastic woven fabric indicating a flawed section of the plastic woven fabric, attaching at least one label to the flawed section of the plastic woven fabric.

11. A method for monitoring flaws of a plastic woven fabric labelled as flawed in particular according to the method according to claim 10, characterized by detecting labels in the plastic woven fabric, identifying flawed sections of the plastic woven fabric on the basis of the positions of the labels detected, and separating the sections identified as flawed either manually or by means of a discharge station controlled by a processing unit.
